(19) United States
(12) Patent Application Publication
(10) Pub. No.: US 2012/0235383 A1
(43) Pub. Date: Sep. 20, 2012

(54) Truck Hitch and/or Ball Mount Protector

(76) Inventor: Roland Hanes, JR., Archdale, NC (US)

(21) Appl. No.: 13/422,369

(22) Filed: Mar. 16, 2012

Related U.S. Application Data
(60) Provisional application No. 61/453,247, filed on Mar. 16, 2011.

(51) Int. Cl. B60D 1/60; B29C 45/16; B29C 45/00

(52) U.S. Cl. 280/507; 264/328.1; 264/279

(57) ABSTRACT

The invention relates to a device that generates a “halo” around a trailer hitch and/or ball mount on towing equipment. By providing an extended buffer area around a traditional truck ball mount/hitch, the knee, shin, leg or other body part will contact an angled area of the device, producing a glancing effect and avoiding serious pain and/or injury.

This application claims priority under 35 USC 119(e) to U.S. Provisional Application No. 61/453,247 filed Mar. 16, 2011, the content of which is incorporated by reference herein in its entirety.

### FIELD OF THE INVENTION

This invention relates generally to devices that protect a tow ball and at the same time protect personnel from intentional or accidental injurious contact with the exposed parts of a vehicle's towing equipment when towing is not being performed.

### BACKGROUND OF THE INVENTION

Towing equipment on the back of vehicles allows a trailer to be hooked up to the back of the vehicle and allows the transport of the trailer (which may contain goods) to other locations. Standard towing equipment generally comprises a truck hitch and/or a ball mount. When a trailer hitch on a vehicle such as a truck is not being used for hauling a trailer or for some other purpose, the trailer hitch and/or ball mount projects from the back of the vehicle. Anyone who has ever contacted their shin and/or knee and/or leg or other body part on a truck hitch and/or ball mount recognizes the severe pain that may result from such contact. Accordingly, the truck hitch and/or ball mount was designed with reducing the pain associated with such contact.

### BRIEF SUMMARY OF THE INVENTION

The present invention, in one embodiment, relates to a device that fits around a truck hitch/ball mount, providing a “halo” of protection eliminating the possibility of direct contact with knees or shins or other body parts of a human with the trailer hitch and/or ball mount.

### BRIEF DESCRIPTION OF THE SEVERAL VIEWS OF THE DRAWING

FIG. 1 shows a front view of an embodiment of the present invention.

FIG. 2 shows a horizontal side view of the base of the device showing sectional views of an embodiment of the present invention.

FIG. 3 shows a perspective view of an embodiment of the invention.

FIG. 4 shows a vertical side view showing sectional views of an embodiment of the present invention.

FIG. 5 shows an expanded vertical side view showing sectional views of an embodiment of the present invention.

FIG. 6 shows a perspective view of an embodiment with two washers.

FIG. 7 shows a front view of an embodiment with two washers.

FIG. 8 shows a side view of an embodiment with two washers.

FIG. 9 shows a perspective view from the top of the device on a trailer hitch with a ball mount.

FIG. 10 shows a perspective view from the top side of the device on a trailer hitch with a ball mount.

FIG. 11 shows a view of the device of the present invention along with a trailer hitch containing a ball mount.

### DETAILED DESCRIPTION OF THE INVENTION

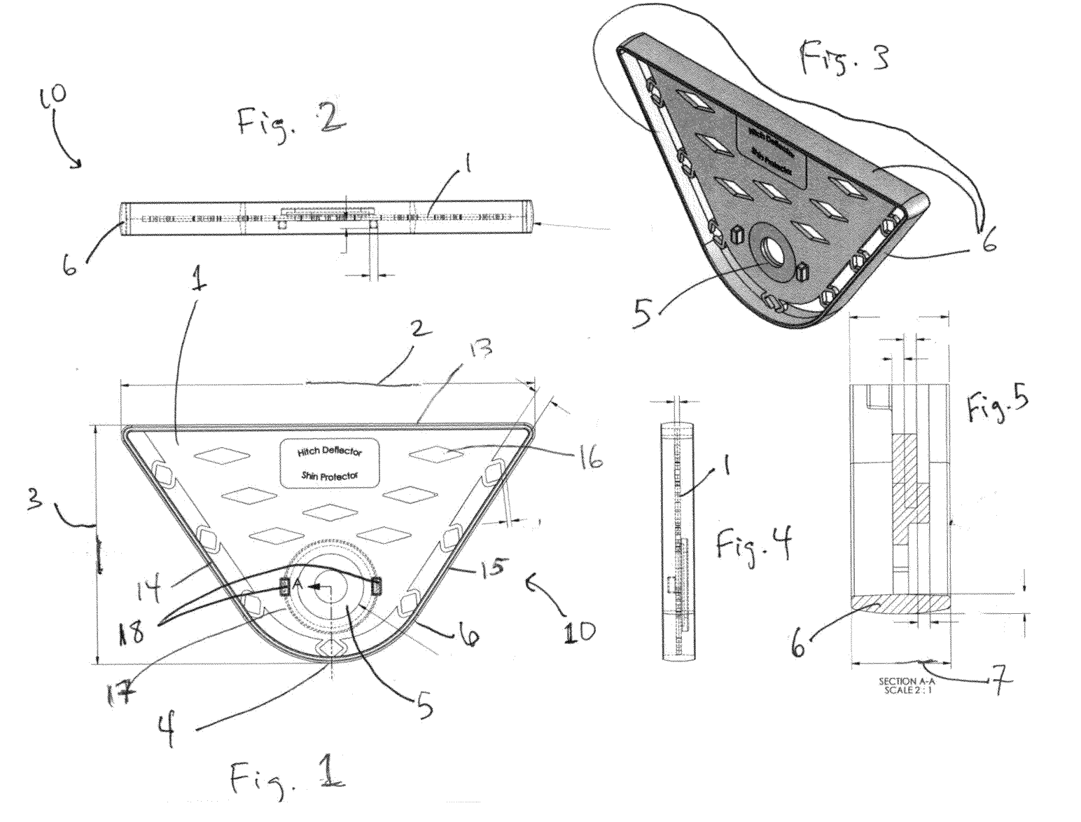

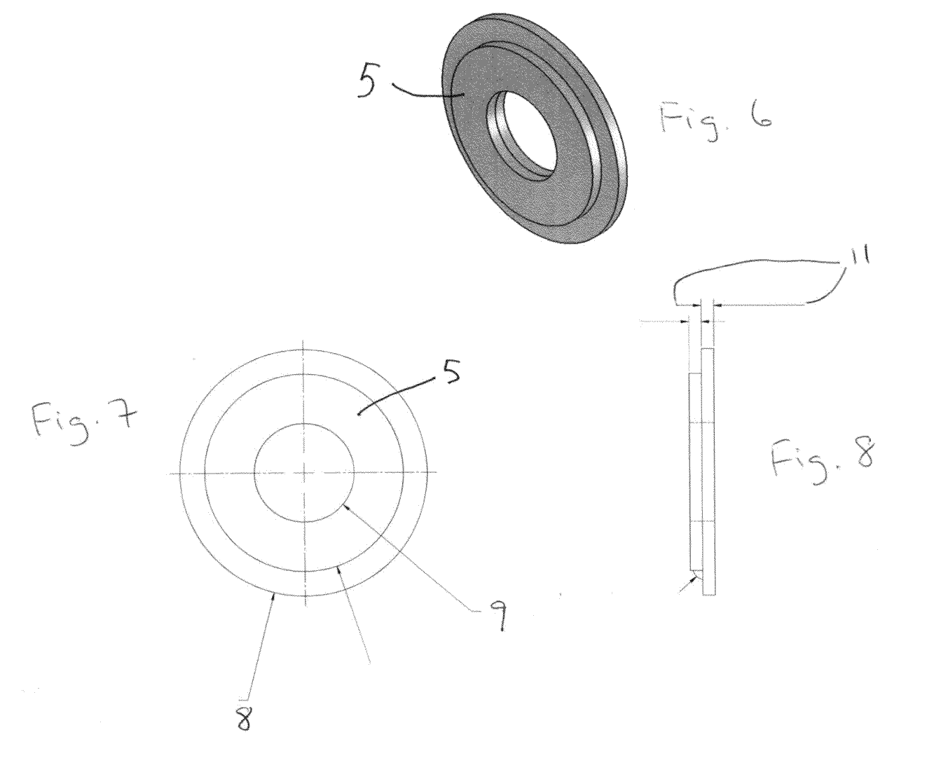

Referring to FIGS. 1 to 5, we describe generally the embodiments of the present invention. In one embodiment, the device 10 is comprised of one or more of the following elements:

A substantially triangular shaped central component 1 approximately 10 to 15 inches across the base 2 and approximately 5 to 9 inches from the center of the base to the apex of the triangle 3. The apex 4 of the substantially triangular shaped central component 1 in one embodiment is rounded (note the rounded edge at apex 4 of edge 6 in FIG. 1). In one embodiment, the substantially triangular shaped central component 1 is about 12 to 14 inches across the base 2 and approximately 5 to 9 inches from the center of the base to the apex of the triangle 3. In a variation, the substantially triangular shaped central component 1 is about 12.525 in length 2 inches across the base 13 and approximately 7.275 inches from the center of the base to the apex 3 of the substantially triangular shaped central component 1. It should be noted that the base 13 (also referred to as a first side) in one embodiment is linear so as to add strength to the device. In embodiments were the base is not linear, the device is more prone to cracking.

In one embodiment, the outside edges 6 (best seen in the perspective view in FIG. 3) of substantially triangular shaped central component 1 are substantially flat and disposed perpendicular to the substantially triangular shaped central component 1 and are in one embodiment, approximately 1 inch in height 7 (best seen in FIG. 5). Although the outside edges 6 are generically given one reference number (6), it should be understood, that there are three sides which make up the outside edges 6. These three sides are first side 13, second side 14 and third side 15. The junction between second side 14 and third side 15 is apex 4.

In one embodiment, one or more metal washers 5 are molded in the center of the central component making a circle with an outer diameter of approximately 2 to 3 inches in the outer diameter. The inner diameter of the one or more washers 5 is of a size to accommodate a ball mount from a trailer hitch. In one embodiment, there exist two or more washers 5 (more than one washer is not shown in the figures). In one variation, the one or more washers, the substantially triangular shaped central component 1 and the outside edges 6 of the substantially triangular shaped central component 1 are part of a kit. Additional washers of different sizes may be present to accommodate a variety of different size ball mounts. The washers may vary in the inside diameter size 9, the thickness 11, or the outside diameter size 8 to accommodate a variety of different size ball mounts 12. Moreover, in one variation, the washers may not be molded to the substantially triangular shaped central component (as shown for example in FIG. 6) but may be designed to fit in a depression in the substantially triangular shaped central component 1 and may be held in place by friction, by glue, by a snap fit mechanism or by some other means known to those of skill in the art.

Accordingly, in one embodiment, the appearance is of a substantially triangular shaped central component 1 with a two to three inch circular hole in its center sitting in the middle of an inch high triangle shaped housing (comprised of the outside edges 6).

In one embodiment, the housing and/or outside edges of the device, at the apexes of the triangle, are rounded to avoid injury. Moreover, the rounded edges may provide additional strength to the outside of the edges 6 of the device. A close view of FIG. 5 reveals that outer edge 6 may actually possess a bit of curvature to further increase the strength of the outer edge yet at the same time provide a surface that allows for better deflection of a shin, knee, leg or other body part.

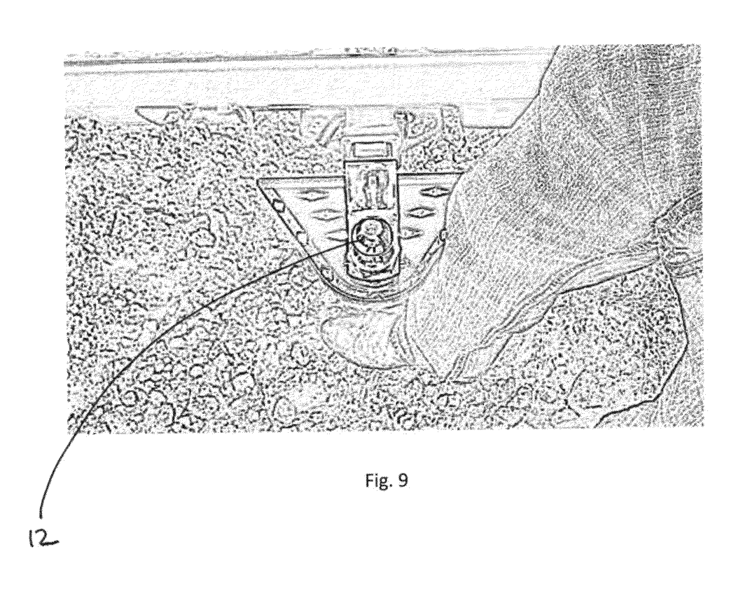

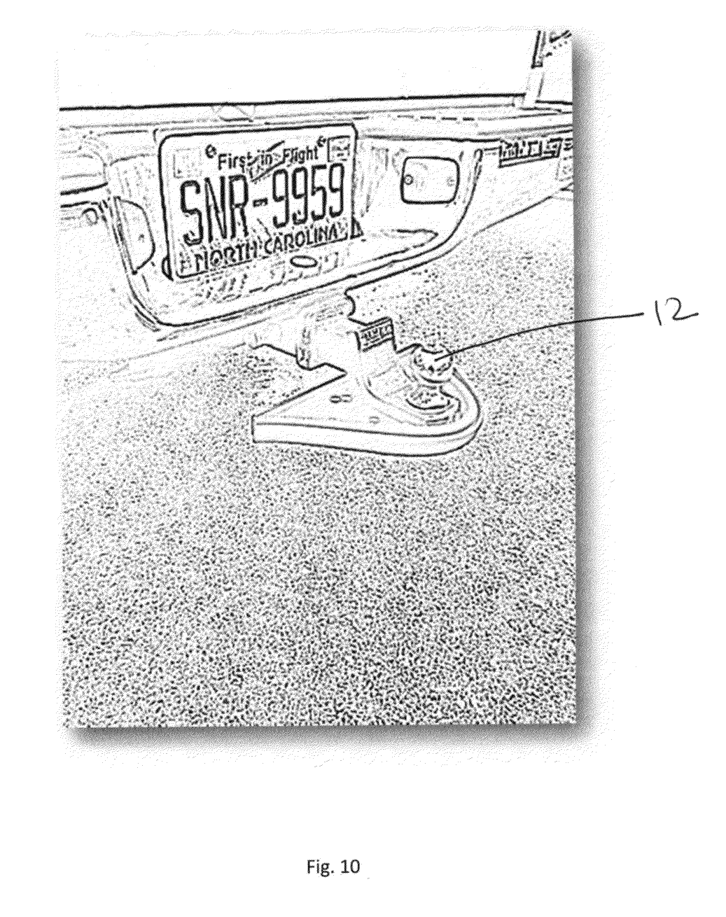

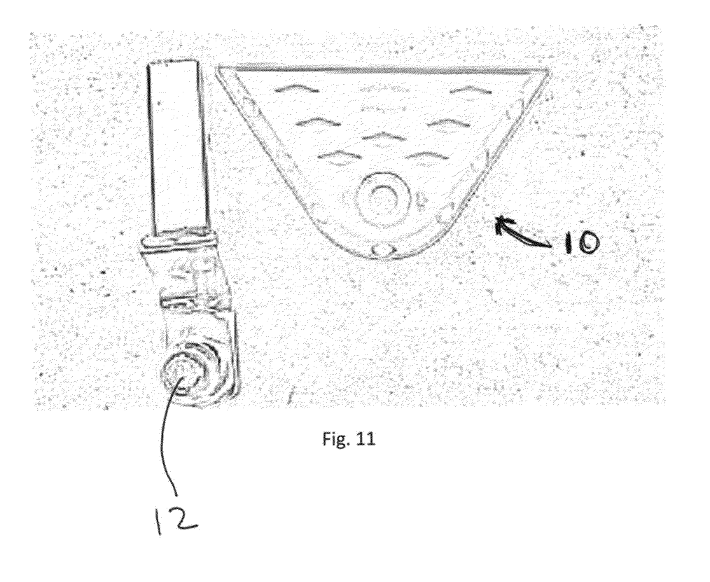

In one embodiment, the center of the device is supported by one or more of diamond shaped cut outs (alternatively referred to as holes 16). Although either one hole 16 or a plurality of holes 16 may be present, in one embodiment, 7 diamond shaped cut outs (holes) between the center and the outside 1 inch high housing are shown. These holes 16 may be designed to provide “give” when the edge of the device comes in contact with a knee or shin or alternatively, may allow the escape of precipitation (i.e., prevent the accumulation of rain water) when rain hits the device (the orientation of the device can best be seen in FIGS. 9 and 10, when the device is attached to the trailer hitch and/or ball mount 12). Although the holes can be any size, in one embodiment, the one or more hole(s) 16 is/are approximately 2 cm in diameter.

In an embodiment, in the middle of the flat surface of the substantially triangular shaped central component 1 is a larger round hole 17 in excess of 2 inches in diameter (best seen in FIG. 1). This hole 17 is molded around two steel washers 5, allowing for firm connection to trailer hitch ball mount 12. It should be noted that in one embodiment, the size of the large round hole 17 is ideally suited to fit the washers 5 in it. The inside diameters of the washer 7 and the large round hole 17 are ideally suited to accommodate a bolt (which is part of a ball mount) so that a tight fit is obtained when the device is disposed on a trailer hitch and/or ball mount. In an embodiment, this secure fit will reduce the likelihood of the device being stolen. That is, if a flexible hole were used (such as one made out of compressible rubber), the device might be easily stolen. However, because the ball mount is likely to be screwed on to a bolt (and the device is between these two parts), stealing the device would require a thief to remove the ball mount. When the metal washer(s) are molded into the plastic, these/this washer(s) and the non-expandable large round hole 17 further secure the device by providing a tight fit for the device. Moreover, when the device is in position on a trailer hitch and/or ball mount, the device does not need to be removed to tow a trailer.

Accordingly, in an embodiment, the present invention relates to a substantially flat, substantially triangular device (i.e., a substantially triangular shaped central component) for protecting a trailer hitch and/or ball mount, wherein said substantially flat, substantially triangular device comprises three sides, a first side, a second side, and a third side, the first side on the triangular device designed so that an entire length of the first side is linear, the second side and the third side disposed such that an apex that occurs at a juncture of the second side and the third side is substantially rounded in nature and said apex is disposed at a maximal distance from the back of the vehicle when the device is disposed on the trailer hitch and/or ball mount.

In a variation, the device further comprises a fixed size hole with a diameter that is of a dimension and a location designed to accommodate the ball mount. In one embodiment, the diameter of the fixed size hole is of a dimension so that the ball mount has to be removed prior to disposing the device on the trailer hitch; and after disposing the device on the trailer hitch, the ball mount is then re-attached to the trailer hitch. In a variation, the fixed size hole comprises a washer. In another variation more than one washer is used (for example, two washers).

In an embodiment, the device comprises a hard plastic. The washers may be metal, or similar to the substantially triangular shaped central component may be made of a hard plastic. In variations of the present invention, the hard plastic is one or more polymers selected from the group consisting of a phenol/formaldehyde polymer, a polyvinylchloride polymer, a polycarbonate polymer, a butadiene styrene copolymer, a polycarbonate butadiene styrene copolymer, a polyetherether ketone polymer, a polyarylether ketone polymer, a clay nanosheet-containing water soluble polymer and mixtures thereof.

Although hard plastic tends to be the cheapest, it should be understood that other materials such as hard rubbers or metals could be used in the device of the present invention including mixtures of materials. For example, in one embodiment, the device further comprises one or more materials selected from rubber and/or metal. Thus, any part can be changed and/or reconfigured by substitution of other materials. In one variation, the substantially triangular shaped central component may be made of heavy duty rubber. In an embodiment, when the device is plastic, the device might also potentially be used as a work table and/or tray as the hard plastic makes for an ideal work/eating surface. Accordingly, this device is ideal for construction type workers, food service individuals or others that may use a trailer.

In one embodiment, the first side, the second side, and the third side are comprised of plastic strips that are substantially perpendicular to the substantially triangular shaped central component.

In an embodiment of the present invention, the device comprises one or more holes in the plastic, which allows precipitation to pass through the substantially triangular shaped central component.

Although in FIGS. 9 and 10, the device is shown as not resting adjacent to or against a back bumper, it should be understood that one design allows the device to rest against a back bumper of a vehicle when the device is disposed on the trailer hitch and/or ball mount.

In several embodiments of the present invention, there may be any of the above mentioned features. Alternatively, one embodiment of the present invention relates to methods of attaching the device of the present invention to a trailer hitch and/or ball mount. Accordingly, the following one or more method steps explain how the device of the present invention may be attached to towing equipment.

The hole 17 and washers 5 allow for the substantially triangular shaped central component 1 to be attached to the hitch/ball mount in the following fashion:

In one method, the towing ball/washer screw is removed from the hitch/ball mount, exposing the bolt which holds the hitch/ball mount.

The device is placed under the ball mount so that the mount sits atop the invention between the two guide posts 18 that reside on either side of the main mounting hole 17 in the invention. In an embodiment, the washer screw is reattached back to the centered ball mount, twisting it until it is tight and flush with the device (i.e., the substantially triangular shaped central component 1). A tight fit is assured by using one or more washers (including the possibility of using lock washers). In one embodiment, two steel washers within the molded component provide a tight fit and allow for a good firm connection to the trailer hitch ball and for ball mount. When installed, the device will sit in between the ball mount and a lock washer (e.g., the lock washer tightens underneath the invention).

Once secured, with the base (i.e., the first side 13) of the invention facing the bumper of the automobile, the device is oriented so that a user will be precluded from having direct contact of the knee, shin, leg or other body part with the actual hitch and/or ball mount.

Accordingly, when securely attached, the result is a rounded triangular device (see FIGS. 9 and 10) sitting between the ball mount and the lock washer (the lock washer tightens underneath the invention), preventing the possibility of direct contact between the hitch/ball mount and the knee or shin.

In one embodiment, any number of the above features may be present in the device of the present invention. Alternatively, all elements discussed above may be incorporated into the device of the present invention. One additional element that could be added is a rubber housing (not shown) to be fitted over the 1 inch edge 6 of the substantially triangular shaped central component 1. This would produce additional cushioning when the knee or shin came into contact with the device. The use of this rubber housing would be particularly useful when the device is manufactured out of steel instead of heavy duty plastic. The rubber housing would not only soften any blow from hitting the steel but could also be used to guard against any sharp edges that result from the manufacture of the device when steel is used.

Once attached to the hitch, the result is a rounded edge triangle sitting between the hitch and the hitch/mount ball making it impossible for the shin or knee to come into direct blunt force contact with the hitch/ball mount. Instead, the shape of the component only allows for “glancing” contact, thus preventing the possibility of direct contact with the hitch/ball mount and reducing the chance of serious injury to the knee or shin.

In one embodiment, the product is designed for one piece injection molding, resulting in a heavy duty final plastic component. The plastics may be any plastic that gives the device sufficient strength so that it is not easily cracked yet at the same time soft enough so that serious injury is not sustained by a person who makes contact with the trailer hitch and/or ball mount. In one embodiment, the mold for plastic injection is based off a steel plug design. In a variation, the device is molded around two steel washers, allowing for firm connection of the device to a trailer hitch ball. Actual steel plug design could also be substituted for heavy duty commercial use with/without rubber housing to be fitted over the 1 inch edge of the triangle component.

Although the substantially triangular shaped central component is shown as a substantially solid device, it should be understood that the substantially triangular shaped central component could be made using a “webbed” center instead of solid center with punched holes. The webbing would not only serve same purpose of releasing rainwater from the face of the product (similar to holes 16), but would also result in a lighter weight device that also has more “give” thereby further reducing the chance of injury when a shin and/or knee and/or leg make contact with the device.

In one embodiment, a steel plug design might be used for heavy duty commercial use (when large loads are being towed) with or without the aforementioned rubber bumper material surrounding the 1 inch edge of the substantially triangular shaped central component.

It is contemplated and therefore within the scope of the invention to include reasonable modifications to the embodiments described above without departing from the spirit and scope of the invention. For example, it is contemplated and therefore within the scope of the invention that any one or more feature(s) that is/are described herein can be combined with any other one or more feature(s).

It should be understood that when a range is given, any and all numbers that fit within the scope of the range are contemplated as potential end points. In any event, the present invention is to be described by the below claims.

We claim:

1. A substantially flat, substantially triangular device for protecting a person from making contact with a trailer hitch and/or ball mount, wherein said substantially flat, substantially triangular device comprises three sides, a first side, a second side, and a third side, the first side on the triangular device designed so that an entire length of the first side is linear, the second side and the third side disposed such that an apex that occurs at a juncture of the second side and the third side is substantially rounded in nature and said apex is disposed at a maximal distance from the back of the vehicle when the device is disposed on the trailer hitch and/or ball mount.

2. The device of claim 1, further comprising a fixed size hole with a diameter that is of a dimension and a location designed to accommodate the ball mount.

3. The device of claim 2, wherein the diameter of the fixed size hole is of a dimension so that the ball mount has to be removed prior to disposing the device on the trailer hitch; and after disposing the device on the trailer hitch, the ball mount is then re-attached to the trailer hitch.

4. The device of claim 3, wherein the fixed size hole comprises a washer.

5. The device of claim 1, wherein the device comprises a hard plastic.

6. The device of claim 5, wherein the hard plastic is one or more polymers selected from the group consisting of a phenol/formaldehyde polymer, a polyvinylchloride polymer, a polycarbonate polymer, a butadiene styrene copolymer, a polycarbonate butadiene styrene copolymer, a polyetherether ketone polymer, a polyarylether ketone polymer, a clay nanosheet-containing water soluble polymer and mixtures thereof.

7. The device of claim 5, wherein the device further comprises one or more materials selected from rubber or metal.

8. The device of claim 1, wherein each of the first side, the second side, and the third side are comprised of plastic strips that are substantially perpendicular to the substantially flat device.

9. The device of claim 5, further comprising one or more holes in the plastic, which allows precipitation to pass through the substantially flat device.

10. The device of claim 1, wherein the first side on the triangular device is designed to rest against a back bumper of a vehicle when the device is disposed on the trailer hitch and/or ball mount.

11. A method of reducing injury from a trailer hitch and/or ball mount on towing equipment comprising attaching a substantially flat, substantially triangular device to said trailer hitch and/or ball mount, wherein said substantially flat, substantially triangular device comprises three sides, a first side, a second side, and a third side, the first side on the triangular device designed so that an entire length of the first side is linear, the second side and the third side disposed such that an apex that occurs at a juncture of the second side and the third side is substantially rounded in nature and said apex is disposed at a maximal distance from the back of the vehicle when the device is disposed on the trailer hitch and/or ball mount.

12. The method of claim 11, wherein the device comprises a hard plastic.

13. The method of claim 11, wherein the hard plastic is one or more polymers selected from the group consisting of a phenol/formaldehyde polymer, a polyvinylchloride polymer, a polycarbonate polymer, a butadiene styrene copolymer, a polycarbonate butadiene styrene copolymer, a polyetherether ketone polymer, a polyarylether ketone polymer, a clay nanosheet-containing water soluble polymer and mixtures thereof.

14. The method of claim 12, wherein the device further comprises one or more materials selected from rubber or metal.

15. The method of claim 11, wherein each of the first side, the second side, and the third side are comprised of plastic strips that are substantially perpendicular to the substantially flat device.

16. The method of claim 12, wherein the device further comprises one or more holes in the plastic, which allows precipitation to pass through the substantially flat device.

17. A method of making a substantially flat, substantially triangular device for protecting a person from contact with a trailer hitch and/or ball mount, wherein said substantially flat, substantially triangular device comprises three sides, a first side, a second side, and a third side, the first side on the triangular device designed so that an entire length of the first side is linear, the second side and the third side disposed such that an apex that occurs at a juncture of the second side and the third side is substantially rounded in nature and said apex is disposed at a maximal distance from the back of the vehicle when the device is disposed on the trailer hitch and/or ball mount, wherein said method comprises injection molding said device.

18. The method of claim 17, wherein said injection molding uses one or more polymers selected from the group consisting of a phenol/formaldehyde polymer, a polyvinylchloride polymer, a polycarbonate polymer, a butadiene styrene copolymer, a polycarbonate butadiene styrene copolymer, a polyetherether ketone polymer, a polyarylether ketone polymer, a clay nanosheet-containing water soluble polymer and mixtures thereof.

19. The method of claim 18, wherein said polymers are injection molded around at least one washer.

20. The method of claim 19, wherein at least two washers are used.
